(19) United States
(12) Patent Application Publication
(10) Pub. No.: US 2014/0323047 A1
(43) Pub. Date: Oct. 30, 2014

(54) Communication System With At Least Two Mobile Parts

(71) Applicant: Toni Werner VOMWEG, Neuwied (DE)

(72) Inventors: Toni Werner Vomweg, Neuwied (DE); Gerd Marmitt, Nonnweiler (DE)

(73) Assignee: Toni Werner VOMWEG, Neuwied (DE)

(21) Appl. No.: 14/239,760

(22) PCT Filed: Aug. 19, 2012
(86) PCT No.: PCT/DE2012/100241

§ 371 Date: Jun. 10, 2014

(30) Foreign Application Priority Data
Aug. 22, 2011 (DE) 10 2011 052 893.8

(51) Int. Cl. H04W 4/00

(52) U.S. Cl. CPC H04W 4/008
USPC 455/41.2

(57) ABSTRACT

A communication system includes at least two mobile parts (1, 2), each of which is paired with a transceiver (5) in order to directly communicate with each other. The transceiver (5) communicates with a computer (6) and with a storing unit (7) in which at least two personality profiles (8) to be individually generated can be stored. A respective first personality profile (8) that corresponds to a first desired profile (10) of the user of the corresponding mobile part (1, 2), the desired profile describing a person is transmitted, and an additional personality profile (8) that corresponds to a desired profile (10) of the user of an additional mobile part (1, 2), said desired profile describing a person, is received. Each received desired profile is compared with a personality profile (8) that corresponds to a self profile (9) which describes the user of the corresponding mobile part (1, 2). If the received desired profile (10) matches the stored self profile (9), a clearly identifiable signaling is carried out between the corresponding mobile parts (1, 2), an automatic communication of the mobile parts (1, 2) being carried out without user interaction solely on the basis of the design of the transceivers (5) and/or the transmittal data.

The present invention relates to a communication system with at least two mobile parts, which are respectively associated with a transceiver for direct communication with one another, a well as a mobile part for use in a communication system.

A variety of communication systems are known in practice. For example, mobile telephones, so-called “handys”, communicate on demand with one another through a respective user, in particular by data exchange.

DE 10 2005 045532 A1 and DE 103 57 305 A1 each essentially describes software products, which have a function that is very similar to the present invention, whereby radio functions, in particular, the so-called Blue-tooth function, of a mobile device is used. The basic concept of a pure software solution is connected with a proportionally minimal expense, but fails in practice due to unavailable access to the Bluetooth interfaces, or respective other wireless interfaces, of a mobile telephone. The Bluetooth interface is defined as the industry standard and is selected over so-called “low-level drivers” of operating systems, for example, of a Smartphone or a game console or the like. If one wishes to connect two devices with one another, the so-called Bluetooth Pairing Process must be performed the first time. The result of this process is a connection key, which in practice is generated by manual interaction and therewith, by accepting of the user on both sides and for further use, is stored in a table of the devices that are communicating with one another. If the devices save the keys, they do not have to perform again the paring process when establishing a new contact. This process is known, for example, in practice from coupling a mobile telephone with an auto-telephone, or a hands-free device with the mobile telephone. Software in a high level language, such as Java, as described in the above noted documents, could first establish a connection with the other two devices via commonly available functions and procedures of the operating system if the pairing process that is administered by the operating system were concluded. A direct access and therewith, an “improper/incorrect” use of the Bluetooth interface, or the radio interface, for example, GSM, or LAN interface, for transmitting profile data or also other essential features, such as the measurement of a signal strength for determining the activation state or indeed distinct adjustments of the range of a radio search radius, cannot be achieved in normal methods. The previously known software products, then, can finally only be developed when, from a manufacturer perspective, access to the driver interface is permitted. A manufacturer-comprehensive functionality represents a problem in practice.

U.S. 2010/0069058 A1 recognizes this limitation and does not attempt to connect the different devices directly to one another. Here, a solution to this problem is provided, in which the devices, respectively, are connected individually by means of the software written thereon with a social network, for example, Facebook. If the devices have access to GPS, the server service written therefore, which is localized in the social network, determines if the devices are located in spatial proximity to one another. Subsequently, a communication channel is established via this server. However, increasing latencies are connected with this solution that relate to location determination and the communication with the central service as well as the system-related inaccuracies of the location determination by GPS.

The present invention, for example, should be helpful in the search for partners that have common features. Innumerable counselors, online portals, dating agents, and dating activities show that many people have an innate interest in finding the right partner for life. With the known approaches, the search for a partner is often subject to time- and location-related limitations. For example, a compatible partner can only be searched within a dating organization or only within the forum of an online portal. Other obvious approaches, such as, for example, special articles of clothing for the partner-search, are in contrast, often suited only for extroverted people.

It is the object of the present invention to provide a communication system of the above-noted type, with which the previously described limitations can be avoided, whereby for direct, wireless communication between two mobile parts, no upstream pairing process or the like must be performed for first-time connections between the mobile parts.

According to the present invention, this object is solved, in that the transceiver communicates with a computer and with a storage unit, in which at least two individual personality profiles to be generated, namely a self profile and a desired profile, can be saved, of which, respectively, a first personality profile, which corresponds to a desired profile of the user of the respective mobile part that describes a person, is transmitted and a further personality profile, which corresponds to a desired profile of the user of a further mobile part that describes a person, is received, whereby the respective received desired profile is compared with a personality profile, which corresponds with a self profile describing the user of the respective mobile part, and with a match of the received desired profile with the saved self profile, a clearly identifiable signaling between the corresponding mobile parts takes place, whereby a self-actuating communication of the mobile parts without user interaction, based alone on the design of the transmitting and receiving units and or the transmitted data, takes place.

The dependent claims represent advantageous embodiments of the invention.

A mobile part used in the frame of the present invention, in contrast to a mobile telephone or Smartphone, requires neither a GSM module nor a display nor a keyboard as an input unit; it can be used as a self-contained unit or a Smartphone can be equipped with the mobile part.

The personality profiles used in the frame of the present invention can include, for example, information regarding sex, that is male or female, age, for example as input of a numeral range, height, likewise preferably as input of a numerical range, zodiac sign, in particular, as a selection from one or two preferable signs of the zodiac, a postal or zip code or a postal code region, schooling/education level, income, for example as input of a numerical range, the goal of relationship search, for example, as a selection of the categories “flirt”, “relationship”, “desire for children”, or the like. The previous types of information are to be understood as examples and can be limited as well as broadened with additional features. With the personality profile, the user of the mobile part can generate and save a personality profile, which describes him, that is, a self profile, as well as a personality profile that describes his desired partner, namely, a desired profile. The transceiver is not an interface that is commonly used in a Smartphone, on which an access must be enabled on the manufacturer side. The transmitting and receiving unit can be installed as a separate component in a Smartphone, in particular, to be exchangeable, and thus uses a card reader, for example an SD or micro-SD, of the Smartphone or a further interface, for example, USB or micro-USB, which for third parties, are freely available and accessible. The transceiver can be associated, from a component consideration, with an antenna, a micro-controller and a storage unit, whereby the actual central computer unit and the power supply, for example, can be associated with the Smartphone. A closed or self-sustaining mobile part is also contemplated, however, which itself has power source and display device or is to be connected with an external power supply and/or a display device, which can be connected temporarily via individual interfaces with a personal computer or a laptop or the like, in order to be relatively easily programmed. Presently, the term communication system is used for the device that includes at least two mobile parts, which of course, also can be designated as a communication device.

The mobile part transmits the personality profile describing the desired partner and receives personality profiles describing desired partners of other mobile parts. In this regard, the mobile parts, which can be any number, use in particular a common radio frequency and the transmitting and receiving takes place offset to one another in determined time intervals, whereby the time intervals, for example, randomly change, such that two mobile parts do not always send or receive at a determined time point and thus, the detection of the signal of the respective other mobile part is barred. The received personality profiles, with which the users of further mobile parts describe the desired partners that they would like to meet, are compared with the personality profile, the self profile describing the user of the mobile part, saved in the individual's own mobile part. Upon matching of the received desired profile with the saved self profile, a clearly identifiable signaling between the corresponding mobile parts takes place. Henceforth, both mobile parts communicate with one another with a clearly identifiable signature, as long as they are in the range of coverage with one another. A prior “recognition” of the mobile parts is not required, in particular no exchange of connection keys that must be accepted via manual interaction, such as for example, with a pairing process of the Bluetooth standard. This would not support recognition of new people, but only finding known people. The communications device or the communications system supports the user of the mobile parts with locating and spatial approximation, when it is determined by the communication process that the profiles match one another, so that finally, a real contact access is possible.

Preferably, upon matching of the received desired profile with the saved self profile, the recognized first mobile part transmits the received desired profile commonly with a signature, which includes the transmitted desired profile of the second mobile part and the desired profile of the first mobile part, whereby the further second mobile part compares the received actual desired profile with the saved desired profile, and with a match, the received desired profile from the first mobile part, compares with the saved second self profile, and depending on the comparison of the first mobile part, clearly communicates or transmits no answer to the first mobile part. Because the recognition sent by the first recognized mobile part sends with it the received desired profile, the further mobile part can first determine after a comparison of the received desire profile with the saved desired profile that it is the correct contact person. When the further mobile part determines a match or agreement in a further comparison of the desired profile of the transmitted mobile part with its self profile, a data signature is generated and sent, which essentially means that the personality profiles on both sides agree.

This data signature comprises, for example, two desired profiles of the mobile parts as well as a randomly generated number, so that the entire data signature represents a possible unique signature, so that the first mobile part and the second mobile part clearly recognize the resulting communication based on the data signature.

For limiting the communication system, it is advantageous to design the transceiver to be switchable on and off and transmit and receive, in particular in a radio frequency in a close-up range, for example, as a device with minimal transmitting power in a license-free frequency band as a short range radio (Short Range Devices, SRD). The user can decide by means of the on/off switch of the transceiver and/or the entire mobile part if he or his mobile part would like to communicate with another mobile part or not.

As close-up range, a distance between two mobile parts, in particular between 0.1 m and 500 m, preferably between 0.1 m and 100 m, and more preferably between 0.1 m and 30 m, is to be understood. The precise range can depend on the design of the mobile parts, in particular the antenna and can be different. By limitation of the range, it is ensured that the users of two mobile parts exchanging data with one another are located in spatial proximity, so that they can find one another when their respective personality profiles match.

According to a further embodiment, the mobile part is formed as a data card, which includes the transceiver and/or an antenna and/or a micro-controller, whereby the data card is insertable in a card reader, in particular, of a Smartphone, but also a tablet computer or a lap top, which is coupled at least with a battery for power supply, and/or a central main computer. The data card can be a so-called SD card or the like, which has contacts that cooperate with counter contacts of the card reader device connected with a computer. The software required to operate the mobile part can itself run, upon assignment of a corresponding computer component to the data card, and execute the entire communication process of the transceiver and transfer over the results of the communication in a suitable type and manner via the interface, in particular the card reader, in which here, for example, a normal storage card is emulated. Further software using the operating system as well as the central computer on a Smartphone including a card reader, a tablet, lap top or similar communication device, can communicate then via standard procedures of the operating system with the interface, formed as a card reader, for example, via reading and writing data on the emulated storage card, so that the software running on the central computer, for example, the display, the keyboard and/or other signal generators of the Smartphone, tablet, lap top or similar communication device for signal generation in the event of a matching profile combination and/or output of the distance measurement can be used. Such software running on the central computer of the Smartphone, tablet, lap top or similar communication device can also be used for input and modification of the profiles, as well as for switching off or on the transceiver. The software running there can have additional functions, such as, for example, the display of the location of the communication partner with the matching profile in a zone or in a diagram.

When both mobile parts exchange data with one another, that is, the agreement of both personality profiles is determined, the transceivers communicate in the determined time intervals with one another, which are measured depending on the distance of the two data-exchanging mobile parts.

Preferably, both mobile parts that are clearly communicating with one another respectively produce a signal that is detectable for the user in dependence on the spatial distance between the two mobile parts. The signal can be formed as any type and for example, can be optical, acoustic, or haptic, for example, the mobile part can vibrate in order to indicate to the user that a user with his desired profile is located in the nearby area, whereby the strength and/or frequency of each time unit of the vibration increases with approaching of the mobile part.

Advantageously, the self profile is not transferable by the transceiver to another mobile part. The self profile serves only for comparison with a received desired profile. Since the self profile typically is not transmitted or is transmitted only after approval by the user, a relative protection for the user is provided.

A mobile part for use in an above-described communication system includes at least one transceiver and/or a switch for generation of the personality profile and/or an interface for transmission of data of the personality profile generated to a computer. For example, a turn switch can be provided for selecting predetermined features or a push button that can be activated repeatedly. Also, the arrangement of a so-called DIP switch (Dual in-line Package Switch) is contemplated, so that the user of the mobile part can generate the personality profile. With a corresponding design of the mobile part, the switch of course can be also other components of a keyboard or a so-called touch screen. In this connection, it should be noted that the personality profile also can be initialized, so that the mobile part can be accepted directly into operation after purchase in a minimal configuration. For comfortable input of the data of the personality profile, a computer is connected via the interface, for example, a so-called USB interface.

So that a user also can generate a personality profile at a different computer without the expense of installation and can store it in the mobile part, it is advantageous in the preferably rewritable storage unit to store a program for generation or modification of the personality profile, which is accessible and executable on one or multiple commercial operating systems.

Advantageously, at least one display device for optically and/or acoustically detectable output of the signal and/or a battery for energy supply of the signal and/or a battery for energy supply is integrated, so far as non-external energy sources or display devices are used.

It is to be understood that the above described features that will be described in greater detail below can be used not only in the respectively provided combinations, but also can be used in other combinations. The frame of the invention is only defined by the claims.

The invention will be described next in greater detail with reference to multiple exemplary embodiments shown in the accompanying drawings. In the figures:

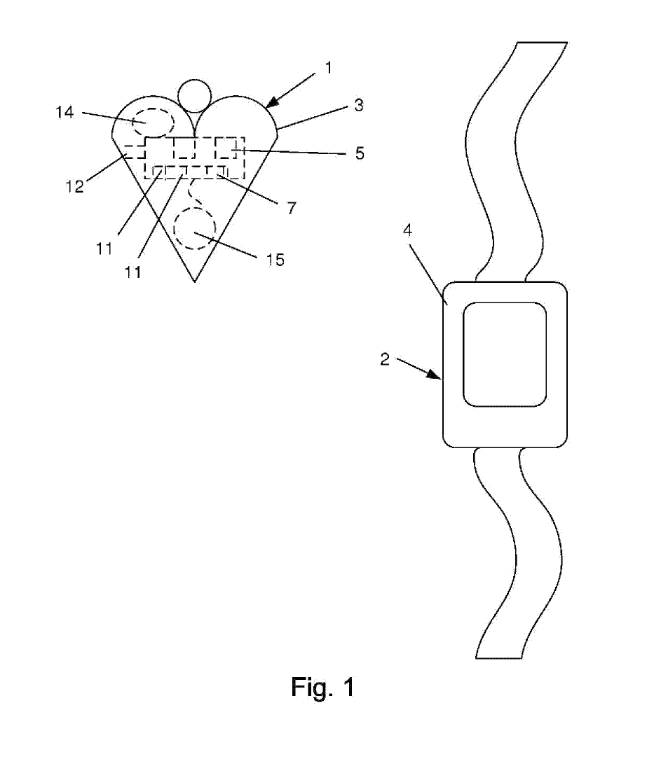

FIG. 1 is a schematic representation of two mobile parts of the communication system according to the present invention;

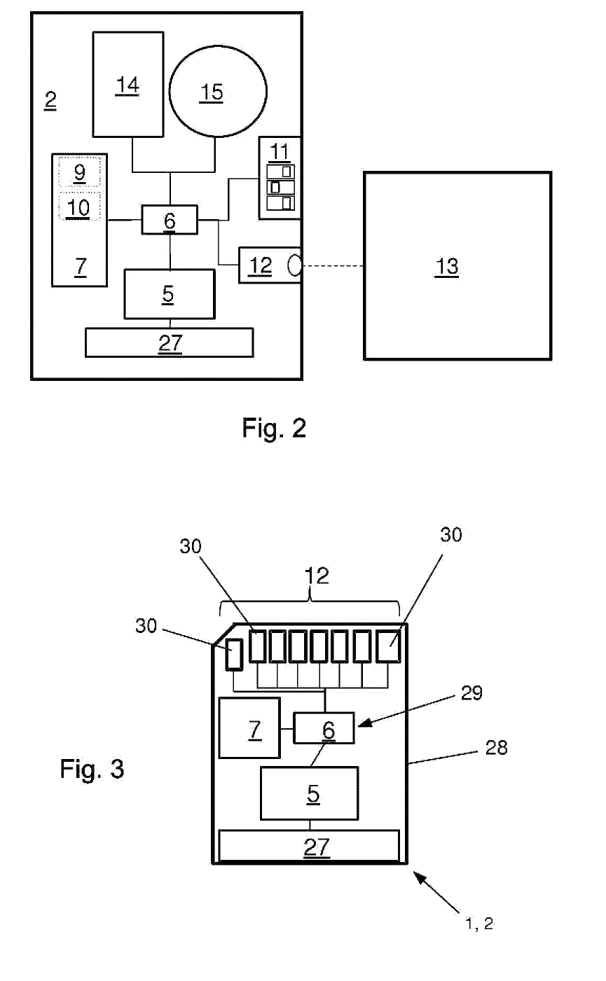

FIG. 2 is a schematic representation of the mobile part in a first alternative embodiment;

FIG. 3 is a schematic representation of the mobile part in a second alternative embodiment;

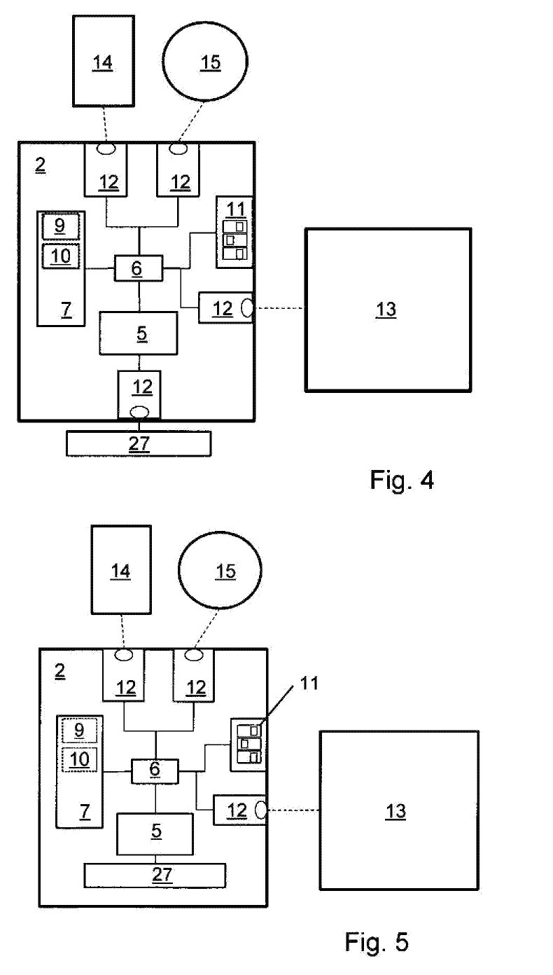

FIG. 4 is a schematic representation of the mobile part in a third alternative embodiment; and

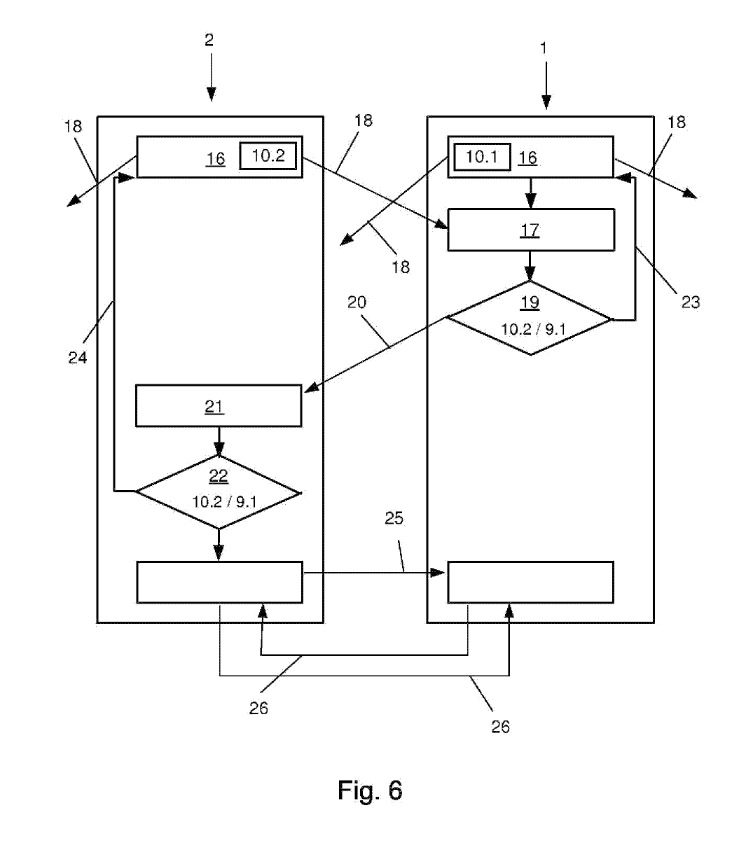

FIG. 5 is a schematic functional representation of the communication system according to FIG. 1.

The communication system includes two mobile parts 1, 2, which presently are formed as pieces of jewelry in the form of a pendant 3 and a wristwatch 4. Of course, the integration of the mobile part 1, 2 in different housings or devices, for example, also a Smartphone or the like, can occur.

Each of the mobile parts 1, 2, includes a transceiver 5 for communication with a further mobile part 1, 2, a computer 6, which communicates with a storage unit 7, in which at least two individual personality profiles 8 to be generated are stored, which are individually generated by the user of the mobile part 1 or 2.

One of the personality profiles 8 is a self profile 9 described a user and a further personality profile is a desired profile 10, which describes a person that the user of mobile part 1 or 2 would like to meet.

The transceiver 5 can be switched on or off by means of a switching device 11 and communicates at a radio frequency in a close-up range. For generation of the personality profile 8, two switches 11 are provided, namely one for the self profile 9 and one for the desired profile 10. In addition, each mobile part 1, 2, has an interface 12 for transmitting data of the personality profile generated on a computer 13, whereby in the rewritable storage unit 7, a program for the generation of the personality profiles 8 is stored. For energy supply of each mobile part 1, 2, a battery 14 is provided. In addition, each mobile part 1, 2, is associated with a display device 15 for outputting a signal that is detectable by the user.

In a first alternative embodiment, the mobile part 1, 2, is formed as a data card 28 in the form of an SD card, which includes the transceiver 5, an antenna 27 and a computer 6 embodied as a micro-controller 29, as well as a storage unit 7. As interfaces 12, contacts 30 are associated with the data cards 28, which cooperate with counter contacts of a card reading device. Via these interfaces 12, the data card 28 can cooperate, for example, with a personal computer, a lap top, a Smartphone or the like, which runs on the respective operating system and for example, uses its battery and/or input device and/or display device.

In further alternative embodiments, the mobile part 1, 2 is formed as a closed component, which is to be connected for configuration and/or for charging of the battery with the computer 13 via its interface 12, which is embodied for example as a USB interface. The mobile parts 1, 2 include the internal or external antenna 27, which is connected with the respective transceiver 5. Further, in addition to an interface 12 for connection of the computer 13, also interfaces 12 for connection of the mobile part 1, 2, with a battery 14 and/or a further display device 15 can be provided.

In operation, when the mobile parts 1, 2 are switched on, each mobile part 1, 2, transmits the desired profile 10.1 or 10.2 that is stored in it, according to field 16, as designated by arrow 18. The transmitting and receiving occurs at a common frequency at different times, which can be varied randomly, whereby the receipt of a desired profile 10 is represented by the field 17. A prior pairing process or similar data exchange for legitimization of the communication of the mobile parts 1, 2 communicating with one another is not necessary. After receipt of the desired profile 10.2 by mobile part 1, mobile part 1 checks in field 19 whether the received desired profile 10.2 agrees with the self profile 9.1 stored in mobile part 1, that is, if the desired profile 10.2 corresponds with the self profile 9.1. If this is not the case, the mobile part 1 transmits further its desired profile 10.1 in determined, irregular intervals, if necessary, which is represented by the back arrow 23.

If the received desired profile 10.2 corresponds to the stored self profile 9.1, then a clearly identifiable signaling of the now sending mobile part 1 takes place, according to arrow 20, which includes the desired profile 10.2, which the receiving mobile part 2 according to field 21 recognizes as the actual desired profile 10.2 and is available for further data receipt. In addition, the transmitted data packet includes a code, for example, in multi-digit numeric or alphanumeric strings, and the desired profile 10.2 of the now-sending mobile part 1.

If the desired profile 10.2 of the now transmitting mobile part 1 does not correspond to the self profile 9.2 of the now-receiving mobile part 2, then the communication terminates between both mobile parts 1, 2, and according to arrow 24, a further transmitting of the actual desired profile 10.2 occurs; alternatively, the mobile part 2, which has received the last data packet, according to arrow 25, transmits information with a code, which includes for its identification at least one part of the received code. This now-sending data packet signals that the reciprocal personality profiles 8 agree. Both mobile parts 1, 2 transmit or receive the same data set according to arrow 26 as long as they are in contact and determine in this manner the distance between the two mobile parts 1, 2, whereby the display device 15 for output of the signal detectable for the user of the respective mobile part 1, 2 is controlled accordingly, the signal changing depending on the distance between the two communicating mobile parts 1, 2.

A personality profile 8 can include, for example, the features of sex, age, height, weight, zodiac sign, education or schooling and/or zip code or further features, which are either concretely selectable or, for example, can be writable by data or area specification. The features can also remain undetermined, when they are unimportant to the user.

With the present communication system, based on the design of the transmitting and receiving devices 5 of the mobile parts 1, 2 or the transmission of the data packet including the code and the desired profile 10.2 of the transmitting mobile part 1, a communication of mobile parts 1, 2 is made possible, which before the communication, were not connected to one another.

### REFERENCE NUMERAL LIST

1 mobile part
2 mobile part
3 pendant
4 wristwatch
5 transceiver
6 computer
7 storage unit
8 personality profile
9 self profile
10 desired profile
11 switch
12 interface
13 computer
14 storage battery
15 display device
16 field
17 field
18 arrow
19 field
20 arrow
21 field
22 field
23 arrow
24 arrow
26 arrow
27 antenna
28 data card
29 micro-controller
30 contacts

1-11. (canceled)

12. A communication system, comprising:
at least two mobile parts (1, 2);
a transceiver (5), wherein said at least two mobile parts (1, 2) are associated for direct communication with one another, respectively, to the transceiver (5);
a computer (6); and
a storage unit (7), wherein the transceiver (5) communicates with the computer (6) and with the storage unit (7), wherein at least two individual personality profiles (8) to be generated are storable in said storage unit (7), wherein one of said at least two individual personality profiles is a first personality profile (8), which corresponds to a first desired profile (10) of a user of one of said at least two mobile parts (1, 2) describing a person, and is sent and a further personality profile (8), which corresponds to a desired profile (10) of the user of a further of said at least two mobile parts (1, 2) desiring a person, is received, whereby the a received desired profile is compared with a stored self profile (9) describing the user of the respective mobile part (1, 2) and upon matching of the received desired profile (10) with the stored self profile (9), a distinctly identifiable signaling between the corresponding mobile parts (1, 2) takes place, whereby a self-actuating communication of the mobile parts occurs without user interaction based alone on the design of the transceivers and/or the transmitted data.

13. The communication system according to claim 12, wherein upon agreement of the received desired profile (10.2) with the stored self profile (9.1), the recognized first mobile part (1) transmits the received desired profile (10.2) with a signature, which includes the transmitted desired profile (10.2) of the second mobile part (2) and the desired profile (10.1) of the first mobile part (1), whereby the further, second mobile part (2) compares the received actual desired profile (10.2) with the stored desired profile (10.2), and upon agreement, compares the received desired profile (10.1) by the first mobile part (1) with the stored second self profile (9.2), and in dependence on the comparison with the first mobile part (1), clearly communicates or sends no answer to the first mobile part (1).

14. The communication system according to claim 13, wherein an answer of the second mobile part (2) directed to the first mobile part (1) includes a distinctive code and at least one part of the signature of the first mobile part, whereby the first mobile part (1) clearly recognizes the second mobile part (2) based on the received part of the signature.

15. The communication system according to claim 12, wherein the transceiver (5) is switchable on and off and sends and receives data in a radio frequency in a close-up range.

16. The communication system according to claim 12, wherein the at least one mobile part (1, 2) is formed as a data card, which includes the transceiver (5) and/or an antenna and/or a micro-controller, wherein the data card is insertable in a card reader of a Smartphone, which is coupled with a battery for power supply, and/or a central primary computer.

17. The communication system according to claim 12, wherein the transceivers (5) communicate with one another in determined time intervals, which is measured in dependence on the spatial distance of the two mobile parts (1, 2) exchanging data with one another.

18. The communication system according to claim 12, wherein the two mobile parts (1, 2) that are clearly communicating with one another, respectively provide a signal that is discernible for the user in dependence on the distance between the two mobile parts (1, 2).

19. The communication system according to claim 12, wherein the self profile (9) is not transmittable by the transceiver (5) to another mobile part (1, 2).

20. A mobile part for use in a communication system according to claim 12, which includes at least one transceiver (5) and a storage unit (7) and/or a switch (11) for generation of the personality profiles (8) and/or an interface (12) for transmittal of data of the personality profile (8) generated on a computer.

21. The mobile part according to claim 20, wherein a program for generation or modification of the personality profile (8) is saved in the storage unit (7), wherein the storage unit (7) is rewritable.

22. The mobile part according to claim 21, wherein at least one display device (15) for optically and/or acoustically detectable outputting of a signal and/or a battery (14) for the energy supply is integrated.
